(19) United States
(12) Patent Application Publication
(10) Pub. No.: US 2016/0055164 A1
(43) Pub. Date: Feb. 25, 2016

(54) NEWS ALERT SYSTEM AND METHOD

(71) Applicant: TLL. LLC, Santa Monica, CA (US)

(72) Inventors: Alejandro Cantarero, Santa Monica, CA (US); Benjamin Feinman Havey, Venice, CA (US); Nathan Haugo, San Francisco, CA (US)

(73) Assignee: TLL, LLC, Santa Monica, CA (US)

(21) Appl. No.: 14/468,010

(22) Filed: Aug. 25, 2014

(51) Int. Cl. G06F 17/30

(52) U.S. Cl. CPC G06F 17/30064; G06F 17/3071; G06F 17/30663; G06F 17/3087

(57) ABSTRACT

A system and method for receiving social media data from multiple social media websites, categorizing the social media data, scoring the social media data, creating clusters of social media data and scoring and ranking the clusters of social media data.

### BACKGROUND

This invention relates to systems and methods for alerting users to and aiding users in discovering trending and breaking news procured from internet traffic.

Since the advent of the internet, the ability to spread information around the world has become easier and easier. Information can spread rapidly through the internet, often in viral and unexpected manners. One popular method for spreading information through the internet has been social media websites. Social media websites are a user friendly tool which allows individuals to spread information instantaneously to anyone with an internet connection.

Broadcasting companies have realized that viral spreading of information is usually news worthy. In an effort to be the first to report such news, broadcasting companies have journalists dedicated to scouring websites, such as social media websites, for news worthy topics. However, in an industry where value is placed on being first, this method of identifying news may be considered slow and inefficient.

Thus, there is a need for an automated system and method for quickly identifying news worthy information from the internet and alerting consumers to such information. The present invention satisfies this and other needs.

### SUMMARY OF THE INVENTION

In its most general aspect, the present invention includes a system and method for identifying news worth information from a media feed and alerting consumers to the existence of the information.

In another aspect, the present invention includes a computer implemented method for identifying news items from a social media data stream, comprising: receiving social media data signals transmitted from a social media server; analyzing the received social media data signals to identify individual social media content items contained in the social media data signals; categorizing the individual social media content items; analyzing the categorized social media content items to determine a scoring value for each categorized social media content item; and ranking the categorized news social media content based on the scoring value of each categorized social media content item.

In another aspect, determining the scoring value for a categorized social media content item includes clustering similar categorized social media content items, and analyzing selected parameters associated with the cluster to determine the scoring value for the categorized social media content item.

In still another aspect, analyzing the categorized social media content items to determine a scoring value of each categorized social media content item includes analyzing parameters selected from the group of parameters consisting of a number of times the categorized social media content item is shared, a value related to changes in the rate of shares of the social media content item over a selected time period, and a value related to a time that the social media content item was first received.

In yet another aspect, the invention also includes transmitting each individual social media content item through a natural language processor specifically programmed to determine a content value associated with the individual social media content item, and annotating each individual social media content item based on the content value.

In still another aspect, categorizing the social media content items includes categorizing the social media content items in accordance with a geolocation value related to the social media content item. In one alternative aspect, the geolocation value is determined by identifying keywords or linguistic features associated with the social media content item. In still another alternative aspect, the keywords or linguistic features are related to a specific location. In yet another alternative aspect, the specific location is selected from the group of locations consisting of towns, cities, regions and countries.

In a further aspect, the geolocation value is determined by predicting the geolocation of a user associated with the social media content item based on data related to the user. In an alternative aspect, the data related to the user is determined by analyzing social connections associated with the user. In yet another alternative aspect, the data related to the user is determined by analyzing posting data history data associated with the user.

In another further aspect, the invention includes transmitting a data item associated with the clustered social media content item the number of categorized social media content item in a cluster exceeds a predetermined threshold.

In still another aspect, the invention includes a system comprising: one or more processors; logic encoded in one or more non-transitory computer-readable media that, when executed by the one or more processors, is operable to: receive signals associated with social media content data from a social media website, transform the received signals associated with social media content data into social media content items, categorize the social media content items into different news categories, analyze the categorized social media content items to determine a scoring value for each categorized social media content item, and rank each of the categorized social media content items based on the scoring value of the categorized social media content item.

In another aspect the scoring value is determined from data in the group of data consisting of a number of times the social media content item is shared, a value related to changes in the rate of shares of the social media data item over a selected time period, and a value related to a time that the social media content item was received.

In still another aspect, the logic encoded in one or more non-transitory computer-readable media that, when executed by the one or more processors, is further operable to cluster similar categorized social media content items, and to determine a scoring value for the clustered social media content items. In one alternative aspect, the logic encoded in one or more non-transitory computer-readable media that, when executed by the one or more processors, is further operable to transmit a data item associated with the clustered social media data items to a user when the scoring value exceeds a predetermined threshold. In another alternative aspect, the data item is transmitted to a user in a form selected from the group consisting of an email, a text message, a push notification and a visual display.

In yet another aspect, the invention includes a system for identifying news from social media comprising: one or more processors configured to: receive signals associated with social media data from a social media website, transform the signals associated with social media data into social media content items, categorize the received social media content items in accordance with a set or preselected parameters, one of which may be a locality associated with the social media content item, score the social media content item to determine a scoring value associated with the social media content item, create clusters of the scored social media content items in accordance with cluster values determined from the scored social media content items, determine a meta score for each cluster, and rank the clusters of social media content items in accordance with the meta score of each cluster.

In another aspect, the one or more processors are further configured to determine a frequency value related to a number of times a social media content item has been shared, an acceleration value related to a change in the rate of shares of the social media content item over a selected time period, and an origination time value related to a time that the signal associated with a social media content item was first received from the social media website. In an alternative aspect, the one or more processors are further configured to display the frequency value, the acceleration value and the origination time value associated with a social media content item in a graphical user interface.

In still another aspect, the present invention includes a computer implemented method for identifying and obtaining rights clearance for social medial content items to be displayed to a user, comprising: receiving social media data signals transmitted from a social media server; transforming the social media data signals into individual social media content items; analyzing the individual social media content items to identify whether clearance from an originator of the social media content item is required before the social media content item can be displayed to a user; searching a database containing clearance information associated with social media content originators and determining if the originator of the social media content item has granted clearance to display the social media content item and acquiring clearance from the originator if clearance is needed; and displaying the social media content item to the user.

In one aspect, acquiring clearance from the originator includes automatically contacting the originator and requesting clearance for the social media content item and processing the originator's reply before the social media content item is displayed to the user. In another aspect, the database containing clearance information associated with social media content originators is updated automatically as new social media content signals are received and transformed into social media content items.

Other features and advantages of the invention will become apparent from the following detailed description, taken in conjunction with the accompanying drawings, which illustrate, by way of example, the features of the invention.

### BRIEF DESCRIPTION OF THE DRAWINGS

FIG. 1 is an exemplary network environment for a news identification and alert system.

FIG. 2 is a block diagram of an exemplary system for identifying news from internet postings and providing alerts to clients.

FIG. 3 is a flow chart illustrating an exemplary system for determining the locality of a poster or the post's content.

FIG. 4 is a flowchart illustrating an exemplary system for scoring and ranking content.

FIGS. 5A-5C depict a flow chart illustrating an exemplary user interface for finding news content from social media networks and publishing the news content to a user.

FIG. 6 is a flow chart illustrating an exemplary graphical system for publishing social media content to a user.

FIG. 7 illustrates an exemplary graphical user interface for a content curation system for finding social media posts about news events and integrating those posts into a visualization experience.

FIG. 8 is an exemplary system for identifying and clearing content publishing rights.

FIGS. 9A-9E depict a flow chart illustrating an exemplary system for discovering trending and breaking content from social media websites.

FIG. 10 illustrates an exemplary user interface for discovering trending and breaking content from social media websites.

FIG. 11 illustrates an exemplary user interface for displaying detailed information on a cluster of content as determined by the news tracker system.

FIG. 12 illustrates an exemplary computer system that may be programmed using appropriate software settings and commands to perform the functions of the various embodiments of a news identification and alert system in accordance with the present invention.

### DETAILED DESCRIPTION OF THE PREFERRED EMBODIMENTS

As will be described hereinafter in greater detail, the various embodiments of the present invention relate to a system and method for processing internet postings for identifying news worthy information and an alert system for alerting users to the discovered news. For purposes of explanation, specific nomenclature is set forth to provide a thorough understanding of the present invention. Description of specific applications and methods are provided only as examples. Various modifications to the embodiments will be readily apparent to those skilled in the art and the general principles defined herein may be applied to other embodiments and applications without departing from the spirit and scope of the invention. Thus the present invention is not intended to be limited to the embodiments shown, but is to be accorded the widest scope consistent with the principles and steps disclosed herein.

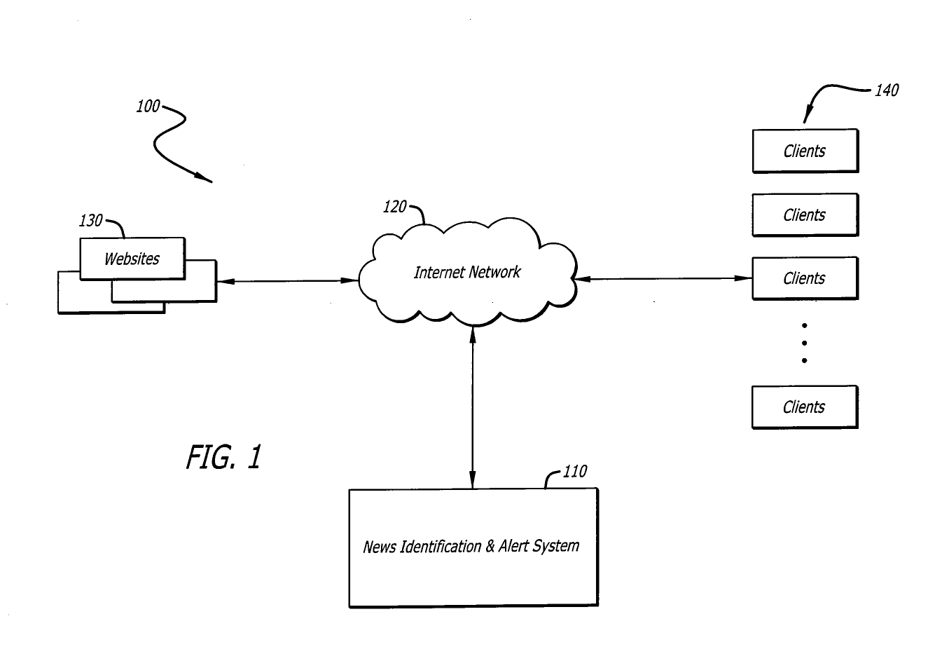

FIG. 1 is an exemplary network diagram of a system environment 100 for identifying and providing news from internet postings. System environment 100 may have a news identification and alert system 110 which may be one or more computer systems that are connected to an internet network 120 which is also connected to websites 130 and clients 140. The news identification and alert system 110 may be configured to receive and process internet postings and content from the websites 130. Postings from websites 130 may include, but are not limited to, data from blogs, forums, YouTube®, Reddit®, Instagram®, Vine®, Twitter®, Facebook®, Google+®, RSS feeds, and the like. News identification and alert system 110 processes the internet postings received from web sites 130, identifies breaking and trending news topics, and sends alerts of the breaking news topics to clients 140.

Clients 140 may access data provided by news identification and alert system 110 or receive alerts from news identification and alert system 110 through Internet Network 120. In an alternative embodiment clients 140 may have access to data from the news identification and alert system 110 through a mobile network, telephone network, or other data network.

News identification and alert system 110 may be configured to provide clients 140 access to data through a web interface, web application, mobile application, data API, or other application interfaces.

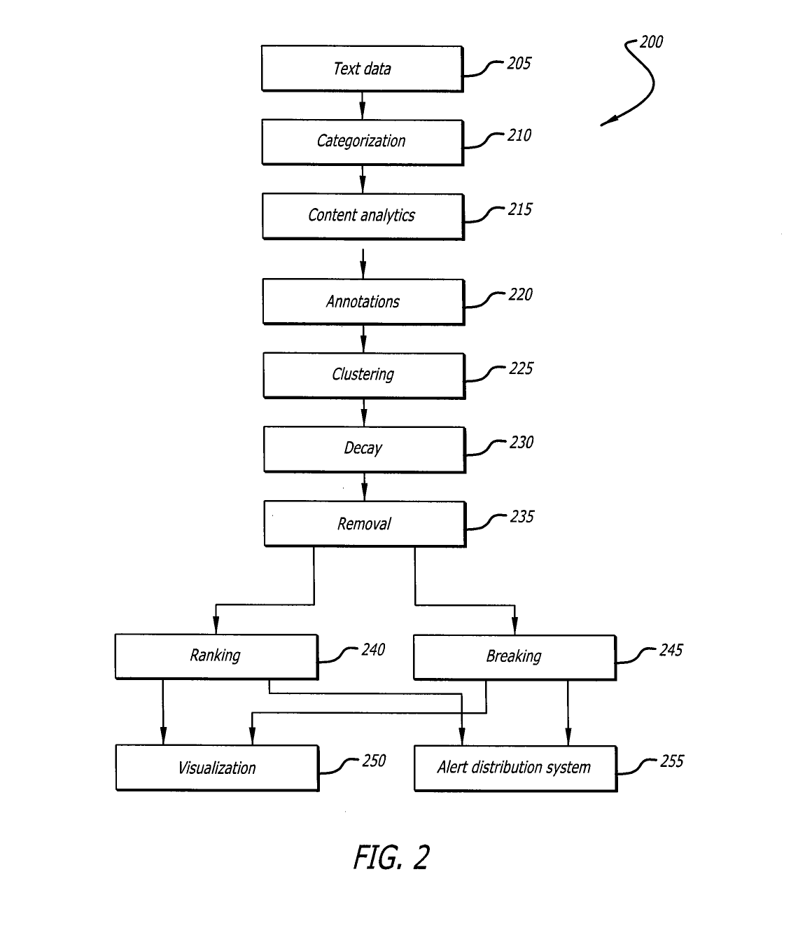

FIG. 2 illustrates a block diagram of an exemplary news identification and alert system 200 for identifying news from website data including social media sites and alerting clients to the discovered news.

At box 205, system 200 receives signals representing data from various websites. This data represented by the signals may be in the form of user posts or messages. The posts may contain textual messages, links to webpages, photos, videos, or any combination of these data. System 200 may have access to social media data through an application programming interface (API) that is provided by a website. Some websites also provide access to a “fire hose” or pipeline which provides social media data in real time. An example of a fire hose is the Twitter® fire hose. Twitter®'s fire hose streams all Twitter® posts in real time to any program that has access to the Twitter® fire hose.

If a social media website does not provide an API or access to its fire hose, system 200 may retrieve social medial data in other manners. For example, web text data, including social media data, may also be retrieved through RSS feeds and other feeds, webcrawling, and the like. Data may also be received from a third-party reseller such as GNIP®, Datasift®, and the like. One of ordinary skill in the art will recognize that there are many ways for system 200 to retrieve social media data, all of which are contemplated here within. In one embodiment, system 200 may identify and record the source of the social media data, such as the particular social media website and/or its author.

Referring back to box 205, system 200 may filter or categorize the received data at box 220. In one embodiment, such a categorization may be as simple as “news” or “not news”. It could also breakdown news by categories such as “shootings”, “bomb threats”, “health”, politics”, and the like. Such a distinction could be made by using a Natural Language Processing (NLP) engine to identify linguistic features that would indicate the data is news or not news. Linguistic features of textual data may use a variety of characteristics of human language, including but not limited to syntactic structure; morphological structure; phonological sound patterns such as rhyme, rhythm and meter; textual indicators of phonetic characteristics such as stress, duration, intensity and tone; and lexical and phrasal semantic features such as sense, denotations, connotations, and presuppositions. For example, a simple rule for identify news related to gun violence may search the text for matches of words such as shot(s), shooting(s), gunman, gunmen, gunshot(s), and the like.

In an alternative embodiment, system 200 may search for a combination of multiple key words or phrases. In yet another alternative, system 200 may use two or more groups of key words for determining whether a posting is related to a topic. For example, there may be a first group with the key words “shooting” and “gunman” and second group with the key words “campus” and “school.” System 200 may require that at least one word from group 1 and group 2 are found in a social media post, message, and/or shared link for the social media data to be tagged as a potential national news topic. System 200 may also account for false positives when doing a keyword search. For example, key words may often come up in non-newsworthy contexts. The keyword “shooting” may refer to a videogame or a basketball game rather than a gun shooting. In one embodiment, system 200 may have a database containing a group of false positive key words, such as “basketball”, and may ignore posts that contain the false positive key words. One of ordinary skill in the art would recognize that there are multiple methods to identify national news topics based on key words, all of which are contemplated here within.

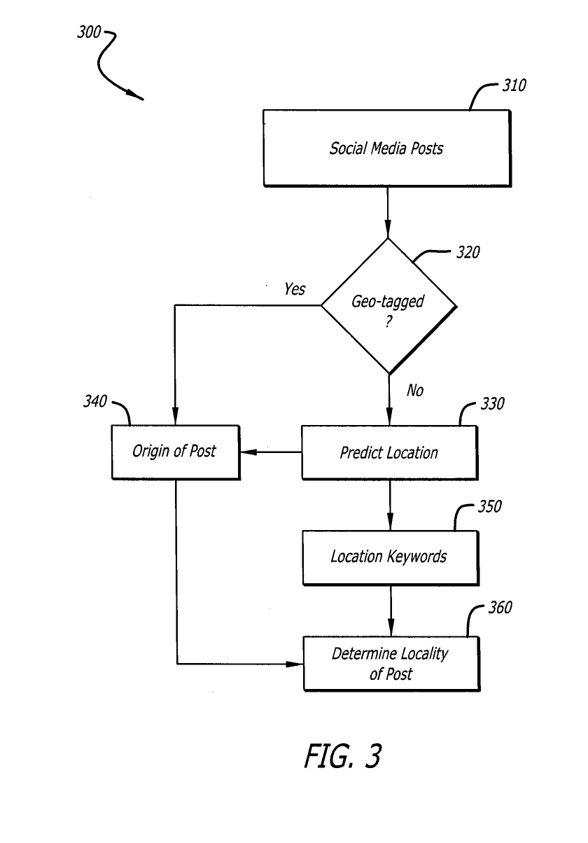

In yet another embodiment, categorization step 210 may distinguish between global, national, and local news. FIG. 3 illustrates an exemplary system for performing this type of categorization. Posts from social media networks may arrive in the system at 310. At box 320, the metadata provided by the social network may be checked to see if any location data was provided for this post. Some social media sites provide geolocation data when a user publishes a post. For example, Twitter® has a Tweet® location feature which attaches the latitudinal and longitudinal location of a poster's location to a poster's post. Twitter® also allows for posters to manually attach a place, city, or neighborhood to a post. Other social media websites may provide similar functions. At box 320, system 300 may be configured to detect the existence of geolocation data for a post from the social media data and use the geolocation data to determine a geographical location for the post and/or social media data at box 340.

If no such data were provided, a prediction may be made as to the users' location at box 330. Such a prediction can be made in many ways. One approach might look at the post history of a social media user. If they frequently mention known landmarks in a city, state, or country, the user could then be predicted to be located in that place. An alternative approach might look at the graph of the social network and either direct connections between users or predictions of possible connections between users. This graph could then be seeded with users that have known locations from box 320, and that information can then be propagated through the network to predict the location of other users.

In a different embodiment, the locality of a post on a social network might be determined not by the location of the user who created the post, but by the content of the message itself at box 350. For example, if a post uses the phrase “San Francisco”, which is a known city the system can infer that the post is about that city. Similarly if the post mentions a unique landmark, such as the “Eiffel Tower”, system 300 can infer the user is talking about Paris.

In yet another embodiment, the combination of the origin of a post in 340 can be combined with location based keywords 350, to determine additional locality to a social media post. For example, system 300 may have been able to identify that a user is located in Los Angeles and that that user posted a message containing the word “silverlake”, a known neighborhood. This allows system 300 understanding that a local person is speaking about a local feature, providing a high level of locality to the categorization at box 210.

At step 210 in system 200 for identifying news data from websites, any number of categorizations may happen, in any order. Further, such categorizations may depend on each other. Take for example a first step of identifying “not news” versus “news” posts as described in [0020]. Step 210 may then further take posts that have been categorized “news” and applying a more granular label such as “crime” or “politics”. Step 210 may then further take “crime” news and applying a locality label as discussed above to understand where the crime took place. One of ordinary skill in the art would recognize that may possible sets of categorizations may be designed to fulfill different needs.

At box 215, system 200 may compute various analytics on the different content items passing through the news identification system. These may include the total number of shares for a social media post. They may include measures of social reach, which may be computed as the total number of people who received the post. Other measurements that may be computed include share counts over time such as velocity or acceleration, often computed as the difference in share counts between two time buckets. Another measurement that may be considered is whether the content is currently trending up or trending down. In one embodiment, this may be computed as, if the number of shares in a specified time interval (such as 30 minutes) is greater than in the previous time interval, then the content is trending up. The age of a piece of content may also be determined by looking at the timestamp associated with the post. One of ordinary skill in the art would recognize that many different calculations may be made on the post and then later used in system 200.

At box 220, system 200 may add various annotations to the data in the news identification system. An exemplary annotation is an annotation such as “spam source”. This label would be added to the post for any post that is determined to not be newsworthy. Such an annotation may be added to the post using an NLP engine. The NLP engine may use linguistic features and/or metadata from the social network to determine whether a post should be labeled as a “spam source”. For example, if the user has no followers, this could be used to label the user as a spammer. A linguistic feature we might identify is that in a user's profile they use a foreign language such as Korean or Arabic, but at box 210 the post was categorized as US News. In such a case, the post may be annotated as a “spam source”.

In another embodiment, annotations 220 may include that the post is “promotional content” such as a message promoting a sporting event or concert. In yet another embodiment, the annotation might label the post as being a scheduled post that comes out at the same time every day and hence has little news value. Many different annotations are possible and one familiar in the art will see how to generate different annotations and apply them to a post.

In a different embodiment an annotation applied at box 220 may also include a score to associate a level of confidence with the label. These scores may be determined by selecting different features from the NLP engine or from the social metadata. For example, a user might be assigned a score of 5 for the “spam source” annotation if they have 10 followers on Twitter. A user that has 1 follower may be assigned the score 10 as a user with only 1 follower is much less likely to be a regular user than someone with a higher follower count.

At box 225, system 200 may use a clustering algorithm to cluster related posts. For example, all posts related to gun violence in one town may be clustered together while all posts related to gun violence in a different town may be part of a different cluster. System 200 may also have clusters with different levels of granularity. System 200 may even have nested clusters such that there are clusters within clusters. For example, there may be a cluster for the sport of football, and within the football cluster there may be a cluster for all NFC teams and all AFC teams, and within the NFC and AFC team clusters there may be a cluster for each individual NFL team, and so forth. An exemplary clustering algorithm may use an approach such as K-means or agglomerative hierarchical clustering. Any approach to clustering requires a set of features to be used in the clustering. There are many features that could be used including dictionaries of words, phrases, hashtags, usernames, and the like. One familiar in the art will be able to see how to construct many different feature sets that would produce different clustering when using one of the above or similar approaches to clustering data.

At box 230 content and clusters in the system may be decayed over time. As a news story gets older, it becomes less important. There are many ways to decay the importance or score of a piece of content over time including linearly, according to some polynomial, exponentially or any combination of the aforementioned approaches.

In one embodiment, the decay 230 may be the same for all content items. In a different embodiment, the rate of decay may depend on other work previously done in system 200. For example, content analytics at 215 could affect the speed with which something decays. In one instance, the decay rate could be affected by the total share count. Content items that have been shared more times may decay more slowly. In another embodiment, content items with a positive acceleration may exhibit no decay. In other embodiments, the decay may depend on other factors such as the categorization 210 or the annotations 220. In an exemplary case, news about public health issues may decay more slowly than news about a petty crime. One skilled in the art will recognize that there are many different ways that content can decay and that these methods may be chosen to match known behavior of different types of news.

At box 235, content may be removed from the system based on any of the previous steps in system 200. In one embodiment, the content analytics from box 215 may show that the content is no longer trending. This may be determined by noting that no one has shared the content in the last 3 hours. In another embodiment the annotation system 220 may have labeled a post as coming from a “spam source” with a high score. In yet another embodiment, the decay algorithm may have lowered the importance of a piece of old content so far that it should be removed from the system. At box 210 the post may have been categorized as “not news”. These are just a handful of examples of how content might be removed from the news system, and one familiar in the art will be able to develop many other conditions using system 200 to identify news that should be removed.

At box 240, system 200 may score and rank content by its news worthiness. System 200 may use a variety of metrics in one or more algorithms to score the content. System 200 may analyze content for cues that signal that a particular piece of content is significant and/or interesting to the general population or a subsection of the general population. These steps may include items such as the analytics computed at box 215, information from the clusters produced at 225 including but not limited to the number of items in the cluster, the age of content in the cluster, and the analytics of individual content in the cluster. In another embodiment, annotations may be used to rank content. For example a piece of content that has an annotation “promotional tweet” with a low score may not be removed from the system at box 235 since system 200 is not confident that it is bad content, but it may be given a lower score so that it does not feature so prominently in the ranking.

At box 245, system 200 may determine which content or clusters of content are considered breaking news. System 200 may also alert users to the breaking news. System 200 may determine breaking news by generating content scores and ranking content based on the content scores. For example, high scoring content or clusters of high scoring content may be considered as breaking news. System 200 may have a threshold score that content or clusters of content must overcome to be considered breaking news. The threshold levels may be different depending on the size or hierarchy of a cluster, whether it is a single content piece, whether the alert is for national level or local level news, and so forth. Determining whether a cluster of content is local or national news may also depend on the originating locations of the clustered posts. In one embodiment, a client or user may adjust or set the threshold level that system 200 uses for identifying breaking news for that user or client.

The identified breaking news may be sent to an alert distribution system 255 and/or to a news tracker visualization system 250. The alert distribution system may send alerts of breaking news to users through email, SMS, browser alerts, and other communication methods. The alert system may also provide summaries, snippets, blurbs, and/or simple titles as part of its alert.

The new tracker visualization system 250 may, for example, update a display window to provide a visualization of the most up to date and recent news topics. Clients and/or users may be able to access this information through a web browser and/or through a software application.

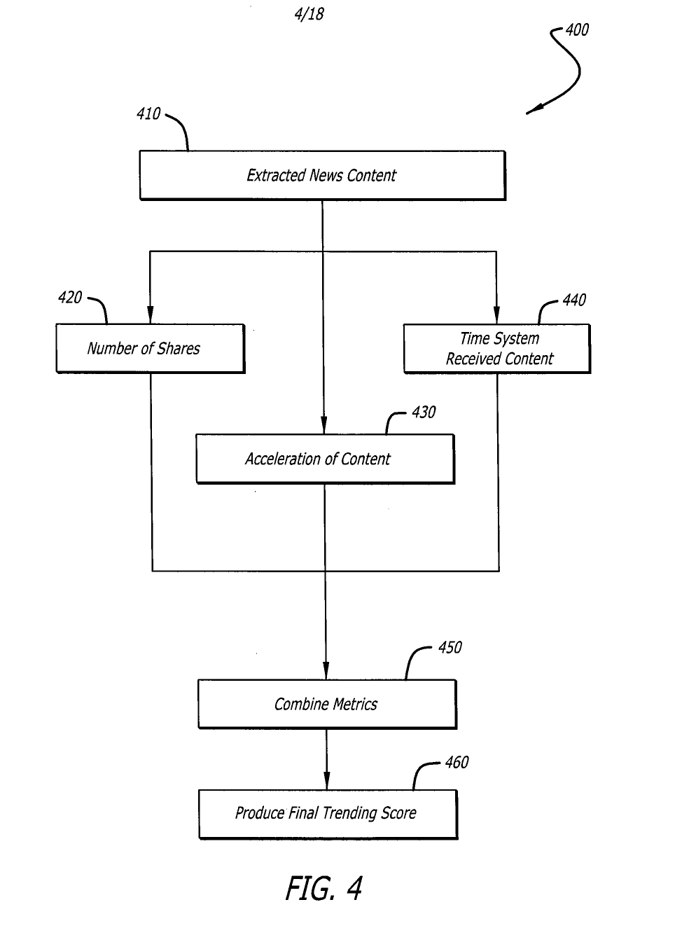

FIG. 4 illustrates an exemplary system 400 for scoring and ranking content for newsworthiness according to one embodiment of the invention. A social media post is received at box 410 for scoring. The number of times the received news content has been shared is determined in box 420. In one embodiment, system 400 may determine the number of times content has been shared by keeping track of all social media data received in one or more databases and tally the number of instances an identical or near identical piece of content is received. Content in the database may be stored for a limited period of time. Other methods of tracking share numbers for content will be apparent to one of ordinary skill in the art and are contemplated here within.

The acceleration of the received news content may be determined at box 430. System 400 may determine the acceleration of the content shares by measuring the difference in share numbers over a time period. For example, a single identical content may be shared increasingly at 100 shares per hour.

At box 440, first receive time of the content is identified. System 400 may timestamp social media data it receives to determine the receive time of any content. Alternatively, system 400 may use a timestamp provided by the originating website. The earliest timestamp for a piece of content may be used to identify the first receive time of the content.

The number of shares, acceleration, receive time metrics may be combined at box 450 to determine a trend score for the content. In one embodiment, the number of shares and acceleration metrics may be used to increase the trend score while the receive time may reduce the score. In one embodiment, the receive time used is the first instance that system 400 received the content.

The following is an exemplary algorithm for combining metrics that preferences content with a positive acceleration:

Number of shares+(acceleration in first hour+⅓ acceleration in 2nd hour+⅙ acceleration in third hour). Equ. 1

Acceleration per hour may be measured as the result of subtracting the number of shares in the previous hour from the number of shares in the current hour. If a full hour of data is not available, the share counts from previous hours may be weighted by the fraction of the current hour that has expired. For example, if ⅓ of the current hour has passed, acceleration may be computed as:

shares in current hour−⅓*shares in previous hour. Equ. 2

In another embodiment, one may want to lend extra weight to the timeliness of the content in the scoring algorithm. In this case, one might add a value C to the above scoring equation where C is 10,000 if the post is less than 10 minutes old, C is equal to 10 if the post is between 10 and 60 minutes old, and C is 0 if the post is greater than 60 minutes old.

A user may be able to change the weight of the number of content shares or acceleration in affecting the content score. For example, an exponent may be added to the number of content shares or acceleration based on a user's preference. One of ordinary skill in the art would recognize that there are many algorithms that may be used to combine these metrics to determine a score for a content's news worthiness, all of which are contemplated here within. The final trending score of the content is determined in box 460, which may be used for ranking, display, or for other purposes.

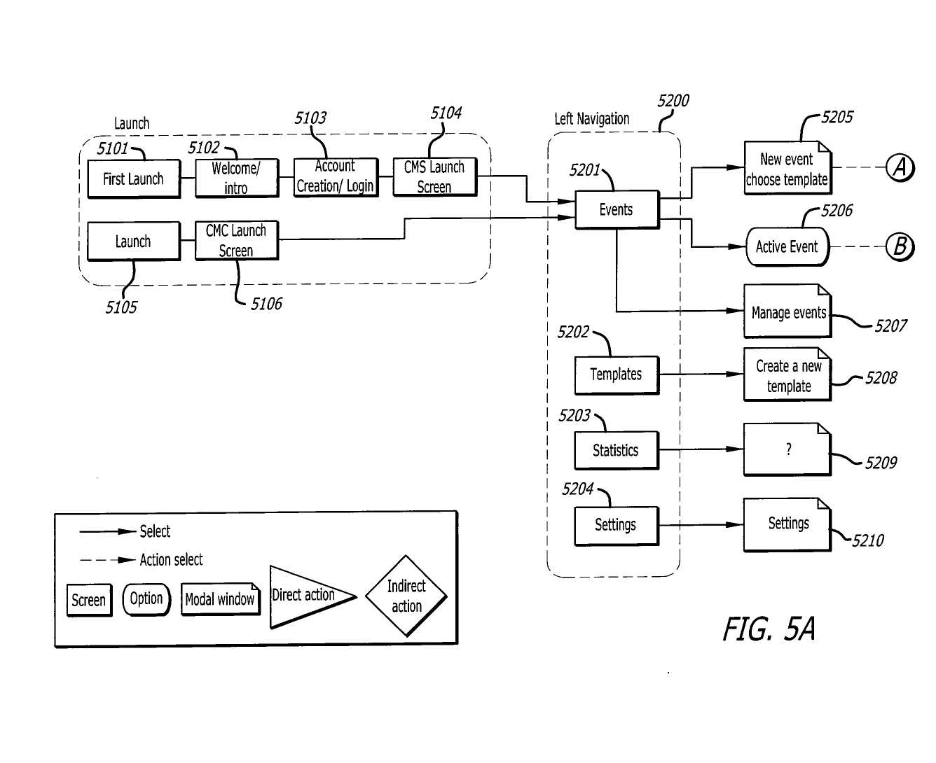

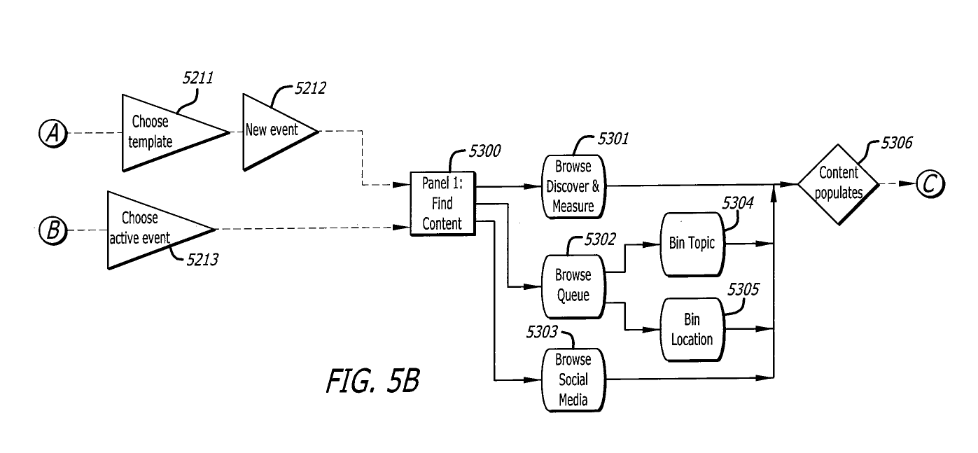

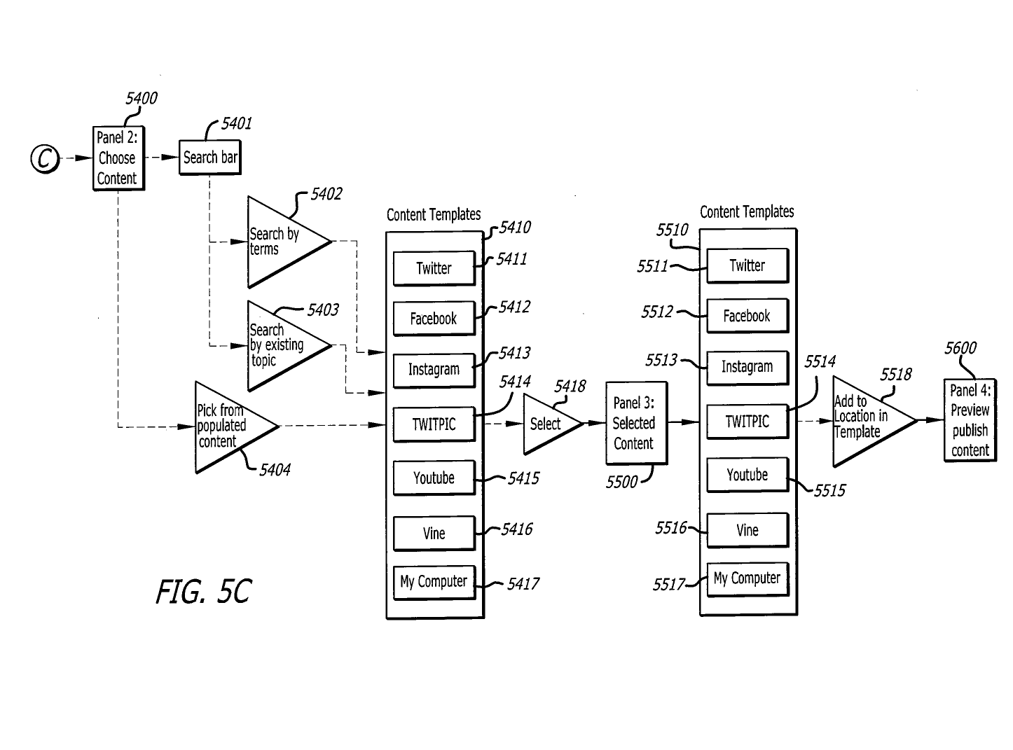

FIGS. 5A-5C illustrate an exemplary flowchart of a user interface that one embodiment of a system for finding news content and integrating it into a broadcast or web experience to a user or a client.

In one embodiment, a user may be presented with differing initial user interface screens depending on whether it is the user's first launch 5101 or subsequent launch 5105 of the user interface. On a first launch 5101, the user may be provided with a welcome/intro screen 5102 and an account creation/login screen 5103 causing the user to login or register an account. Once the user has registered or logged into an account, a content management (CMS) launch screen 5104 may be displayed. On a subsequent launch 5105 of the user interface, the user may be presented with the CMS launch screen 5104, skipping the welcome/intro screen 5102 and account creation/login screen 5103.

CMS launch screen 5104 may display a navigation screen 5200 with a plurality of user selectable elements. The plurality of user selectable elements may include an events screen 5201, templates screen 5202, statistics screen 5203, and a settings screen 5204. Upon the selection of templates screen 5202 a create a new template window 5208 for creating templates for arranging and grouping content may be provided. The create a new template window 5208 may provide a user the ability to determine how content in an event will be organized.

Upon the selection of the statistics screen 4203, the user may be provided with a window 5209 that enables a user to review available statistics and analytical measurements about a discovered news event in the news event detection system. Window 5209 may display analytic measurements such as graphs of content shares for events over a period of time, number of shares, demographic data, geographical data, content publish time, number of likes and/or comments, content source, and the like.

Upon the selection of the settings screen 5204 a settings window 5210 may be displayed to the user with a user interface that allows the user to change certain personal system settings, such as the email address associated with their account or their personal password.

Upon the selection of events window 5201, the user may be presented with several actuatable elements relating to events. An event is a stream of social media content that has been selected by the user to integrate into a broadcast or web display. Content for these events may be selected by the news tracker system or found by custom queries conducted by the user. In one embodiment, the several actuatable elements may include a new event choose template window 5205, an option to edit an active event 5206, and a window to manage events 5207. According to one embodiment, the news tracker system may also provide predetermined streams of content 5208 for a user to choose from.

Actuating the new event choose template window 5205 may cause the user to pick a template 5211 and a new event 5212 resulting in the display of panel 5300. Actuating the option to edit an active event 5206 may cause the user to choose an active event 5213, also resulting in the display of panel 5300.

Panel 5300 may provide the user with a plurality of selectable options related to viewing content. The options may include, for example, a browse discover and measure option 5301, browse queue option 5302, and browse social media option 5303. Selecting the browse queue option may provide additional selectable options of user created bins 5304 and 5305. The user created bins may contain content that the user previously selected from the news tracker system and saved in the selected bin. The number of selectable bins may depend on the number of bins the user created. The browser discover option may allow the user to review content from the news tracker system and measure option 5301 may provide a user with the ability to find analytics around a particular topic that they may wish to integrate to a broadcast or web experience. The browse social media option 5303 may provide a user the ability to perform custom queries on different social media platforms through the API for the website. For example, search terms entered into the search bar may cause a search API for Twitter® to search for Twitter® posts matching the search terms. The API may match for usernames, hashtags, and/or keywords, and the like.

Upon the user selecting a browsing option, process 5306 populates panel 5400 with content, which may be user selectable. The user may be presented with the option of searching through the content with a search bar screen 5401. As another alternative embodiment, panel 5400 may also provide a screen for a user to filter and/or sort the content in the panel. For example, the user may be able to filter content for pictures, videos, messages, articles, and the like. Panel 5400 may also provide the user with a screen that allows a user to sort content based on certain metrics, such as newest, most shared, fastest accelerating, and the like.

The search bar screen 5401 may allow the user to search the content in the panel by search terms 5402 or search by existing topic 5403 before selecting content the user is interested in. The user may also select content 5404 without using search bar screen 5401.

The selectable content may be displayed within a content template screen 5410 which may display content in a template that is optimized based on the source of the content. For example, there may be a Twitter® template 5411, Facebook® template 5412, Instagram® template 5413, Twitter® picture template 5414, YouTube® template 5415, Vine® template 5416, and a template 5417 for content uploaded from the user's computer.

User selected content 5418 may be organized and displayed in panel 5500. The content may be displayed in a template screen 5510 in a similar manner as template screen 5410. Similar to template screen 5410, template screen 5510 may display content in a template optimized for the content source such as Twitter® template 5511, Facebook® template 5512, Instagram® template 5513, Twitter® picture template 5514, YouTube® template 5515, Vine® template 5516, and a template 5517 for content uploaded from the computer.

The user may be allowed to select content displayed in panel 5500 and further manipulate that content. Examples of such actions might be to reorder the content in panel 5500 or remove items from panel 5500. In one embodiment, the user interface may provide a drag and drop function that allows the user to drag content from panel 5400 to 5500. Panel 5600 provides a stream of the content available in Panel 5500. This stream may be used to provide a preview of how a template populated with the user selected content will be displayed. Panel 5600 may also be made available via a standard data API such as a RestFUL json style API or RSS feed directly to a user to use in whatever manner they desire. The user interface may also provide an actuatable option to save and/or publish the template to a website, television screen, or other viewing device.

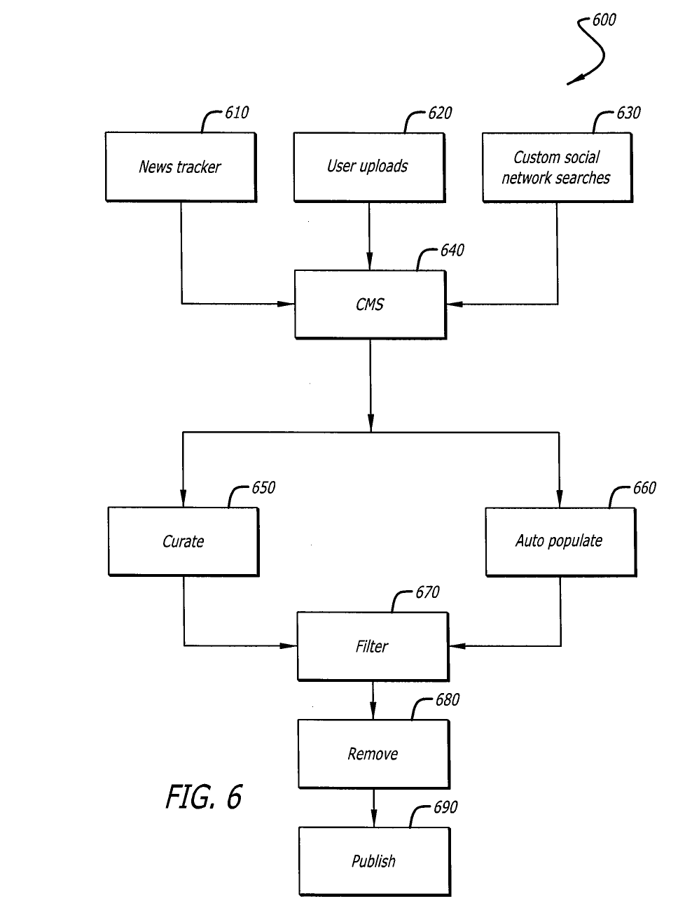

FIG. 6 illustrates an exemplary system through which a user may provide several publishing options such as a streaming option which allows a user to stream content for display on a website, television broadcast, projection and/or other displaying medium. In system 600, the user may connect various content streams into the CMS 640 described above. Streams that may be connected include custom API searches on various social networks 630, streams of content from the news tracker system described above 610, or custom content upload by the user 620. The CMS 640 may operate in two different modes. Curation mode 650, may allow for users to select content in real time for streaming onto a display. In one embodiment, the user selected content may be displayed in rotation with other selected content. System 600 may also provide an automated stream mode option 660. The automatic stream mode option may allow a user to automatically display contented based on a user's selected criteria, such as one or more topic choices and/or keywords.

The user may be provided with the ability to remove content from any of these streams through a variety of filters 670. Filters might be pre-defined. Examples might include, but are not limited to: removing content containing profanity, removing content that does not include an image, or removing posts from users with low follower counts. Users might also define custom filters 670, such as requiring certain keywords, posts must mention “excited” or contain certain hashtags.

In alternative embodiments, additional filter options may be provided to the user for selection, such as display content with only positive or negative sentiment; content that has a share count over a certain number; content from publishers who are above a certain Klout® score, content from publishers with a certain follower threshold, and/or a combination of several criterion.

The user may also be provided with the ability to remove content from display 680. In one embodiment, user may be able to manually select any item in the stream and remove it from the content to be displayed.

In another embodiment, a filter to prevent duplicate content items may be actuated by the user which causes an image detecting system to prevent multiple displays of the same image or multiple images being in the rotation of a steam. The image detection system may identify duplicate images by analyzing images for similar characteristics.

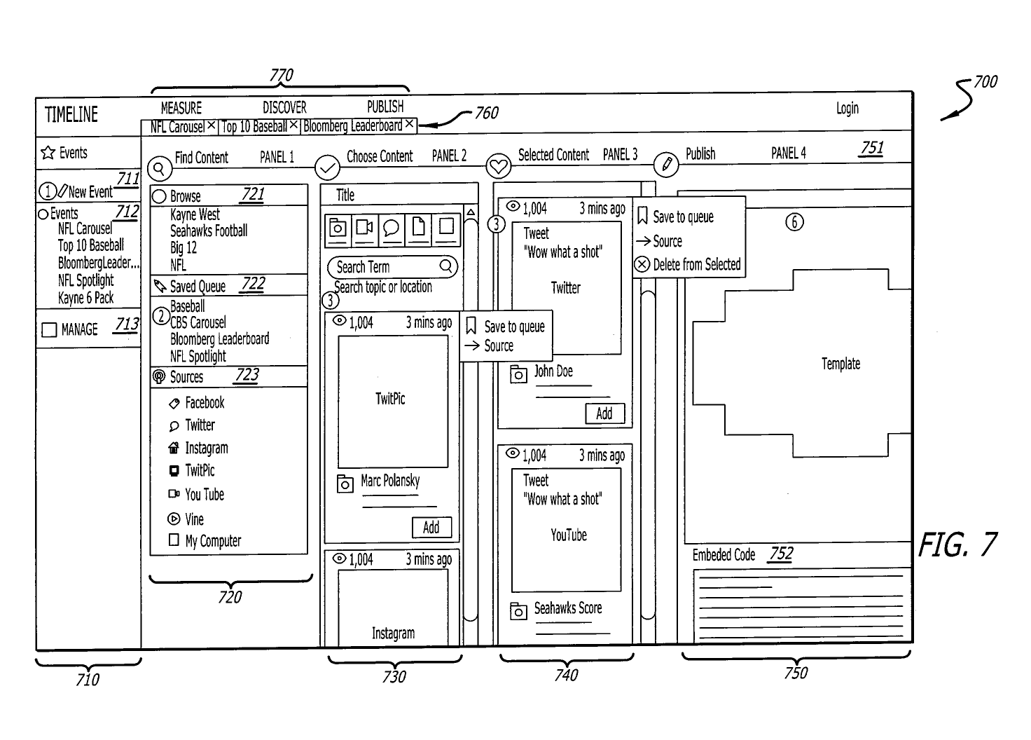

FIG. 7 illustrates an exemplary graphical user interface 700 displayed by the content management system of FIGS. 5A-5C. Graphical user interface 700 may have a navigation bar 710 with clickable selections for creating a new event subpanel 711, a list of existing events that are clickable and select an event that was already created 712, and an ability to manage existing events 713 that may include options such as deleting and renaming events.

Panel 720 may provide the user with the ability to select different streams and load them into panel 730 to find content to provide to a broadcast or web experience. Streams of content defined by the news tracking system may be available at 721. Any streams provided to the user by the system may be available here. At panel 722, the user may select saved collections of content that they have saved while browsing the news tracker system. At panel 723 the user may go directly to a social network and search it for content to add to their stream of content. Based on the user's selection, a panel 730 may display content relevant to the user's selection. Panel 730 may also have a section 731 that allows the user to filter through the content in the panel. There may be a search bar and icons that allow for the user to filter content for pictures, video, messages, articles, or order content by analytical measurements (this may include the rank and/or scoring conducted by system 200 in FIG. 2, receive time, and other metrics). Graphical user interface 700 may display a panel 740 that allows the user to drag and drop user selected content from the panel 730.

In one embodiment, a user may be provided with a save function. For example, content may be saved to a virtual “bin” for the user to browse through. In another embodiment, the CMS may be configured such that a user may have multiple bins, which the user may be able to name. In yet another embodiment, the CMS may also make the items in the bins available for the user to stream onto a webpage, application, live feed, or other news displaying medium.

The graphical user interface 700 may also have a panel 750 that displays a user selected visualization template 751 which may allow the user to drag and drop and organize content from panel 740 into the template 751. Panel 750 may also provide an embedded code 752 if the visualization is a web widget that the user can embed onto their webpage.

The graphical user interface 700 may also allow for tabs 760 such that a user can populate and work on additional templates simultaneously. The graphical user interface 700 may also have clickable links at the top of the user interface to allow a user to access additional functionalities of the news alert system 770, such as metric measurement tools, publishing tools, and discovering content tools.

In one embodiment, the news tracker visualization system may have a system for identifying and clearing content rights for publishing. Certain types of content, such as video and photos, may remain the property of the publisher, and publishing this content may violate the publisher's rights.

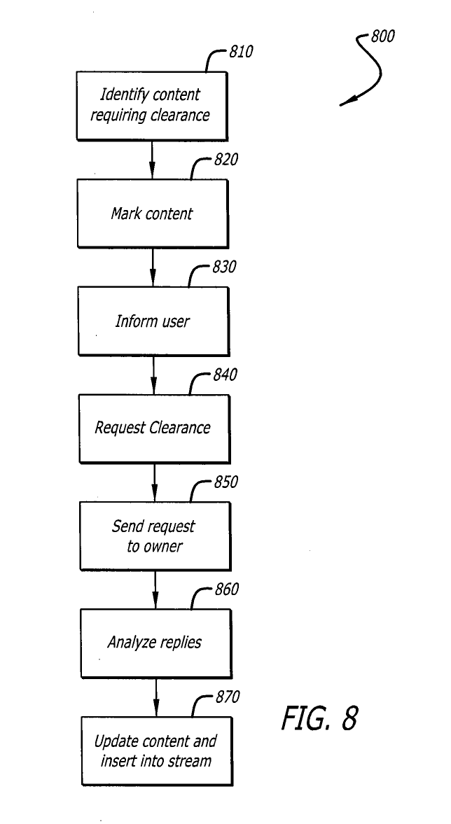

FIG. 8 is a flow chart illustrating an exemplary method for identifying and clearing content rights for publishing. Content that requires clearance is identified at box 810. In one embodiment, content that requires clearance is identified based on the terms of use provided by a publishing website. For example, content in a Twitter® photo may be cleared for any type of display while photos from Instagram may require an author's permission. Additionally a user may have certain agreements with websites or content authors, and clearance status for content from these sources is identified based on the terms of the agreement. For example, a user may have the rights to any images on a particular website but not to any media. Content from a particular website is analyzed in accordance with the terms of the agreement and clearance to the content is attached only if the content falls within the terms of the agreement. In another embodiment, the data from the website may contain information on whether the content creator has flagged the content as being cleared or not cleared for use. System 800 may check to see if this information is available and label the content in the system accordingly.

In another embodiment, a content analysis device or method may be used to analyze media content for indications of professional work. In images, such indications may include the existence of watermarks, information on the color distributions in the image, and/or indications that the content is from a magazine or album cover. In one embodiment, a system for identifying an album or magazine cover may search the image for regions containing text. The number of regions containing text as well as the percentage coverage of the image could be used as indicators for the likelihood that the image falls in this category. If the percent coverage is above a set threshold, the media may be labeled as being a cover. In another embodiment, one might check how many different fonts are used throughout the image. This number may be used by itself or in conjunction with the percentage coverage previously computed to determine that the content is a cover.

In yet another embodiment, similar approaches may be applied to detect professional video content. For example, detecting large amounts of text in the lower-third, upper third or left or right edges of the image or video may be used as a strong indication that the broadcast is a news or sports event containing a ticker. In another embodiment, the region may be searched for the existence of one of the network logos. If found, the presence of the logo would indicate that the content is a professional work.

Returning again to FIG. 8, content is marked as either requiring or not requiring clearance based on clearance requirements at box 820. If a user of the system has selected a content item for a broadcast or web display that requires clearance for that medium, the system may inform the user that this content requires permission to use at box 830. The content may remain in the stream but will not be included while there is an outstanding clearance issue. If clearance is needed, a request clearance option may be provided to the user in box 840. Alternatively, clearance of the content may be automatically requested from the content owner as soon as an item requiring clearance is selected. If clearance is to be requested, an electronic message requesting content publication rights is sent to the owner of a piece of content at box 850. In one embodiment a predetermined default message may be sent to the owner. In an alternative embodiment, a custom message created by the user is sent to the content owner. The contact information of the owner may be extracted from the website that the owner published the content on. In another embodiment, the contact information may be discovered through an internet search. The electronic message may be sent as an email, private message, a direct message or reply on the social network where the original content was posted, or any other electronic message. A responding address for the owner to respond to the request may accompany the message.

The response from the content owner is received and the response is analyzed using a NLP engine at box 860 to determine whether the owner has provided permission to use the owner's content. In one possible embodiment, the NLP engine would normalize responses such as “yes”, “okay”, “no problem”, “sure” or other similar replies into a ‘yes’ answer. A similar approach may be used to determine the answer was ‘no’. The content rights status that was applied at 820 is then updated accordingly at box 870. In an alternative embodiment, the message from the owner may be relayed to the user, so they may review and possibly subsequently follow up with the content producer again. At box 870, system 800 may also check to see if the content item that has received permission to be used is already in existing streams meant for broadcast or web experiences. If it is found in one of these streams, it may be automatically released to appear in those streams immediately after its status has been updated to “cleared”.

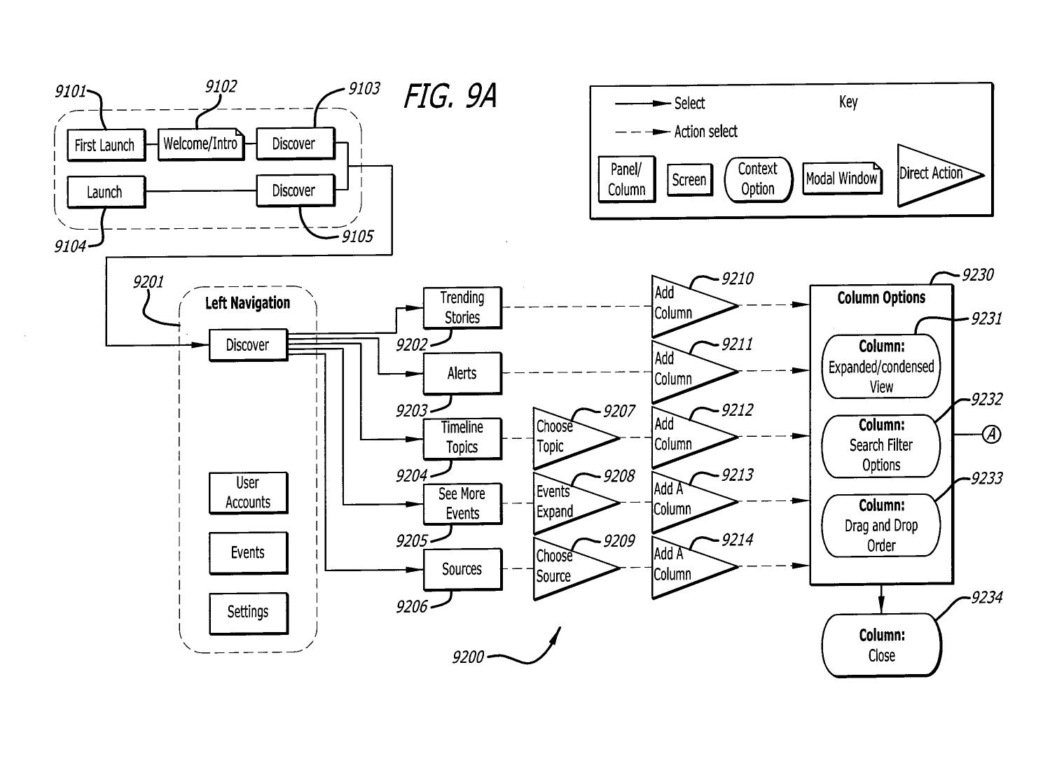

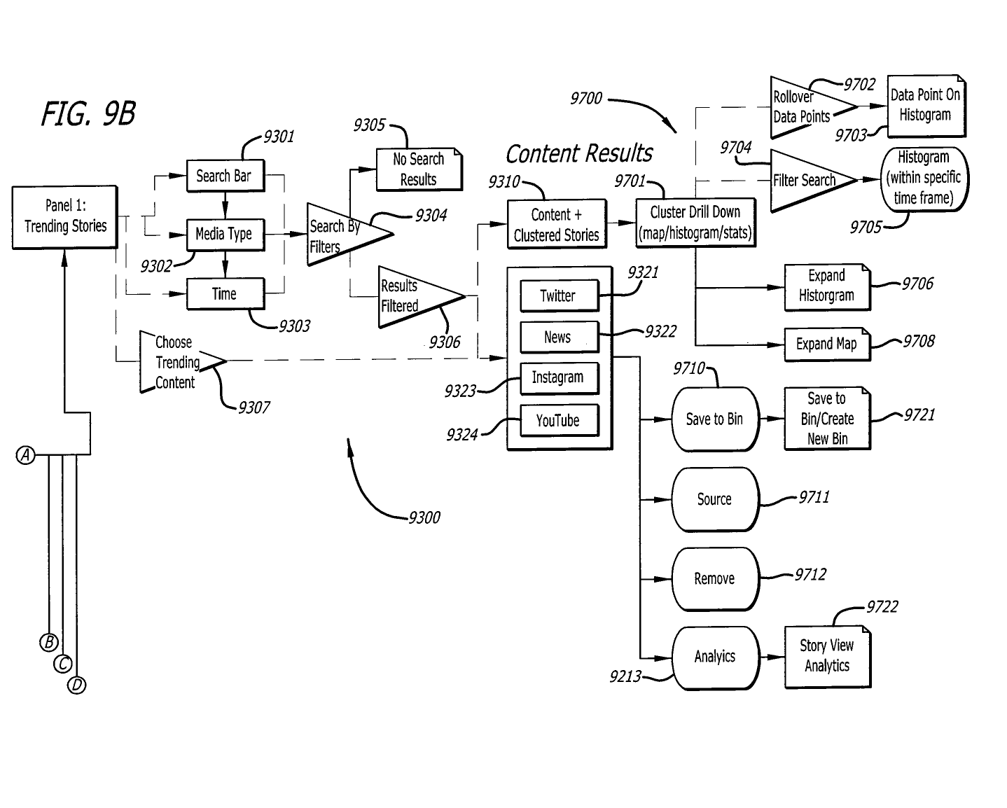

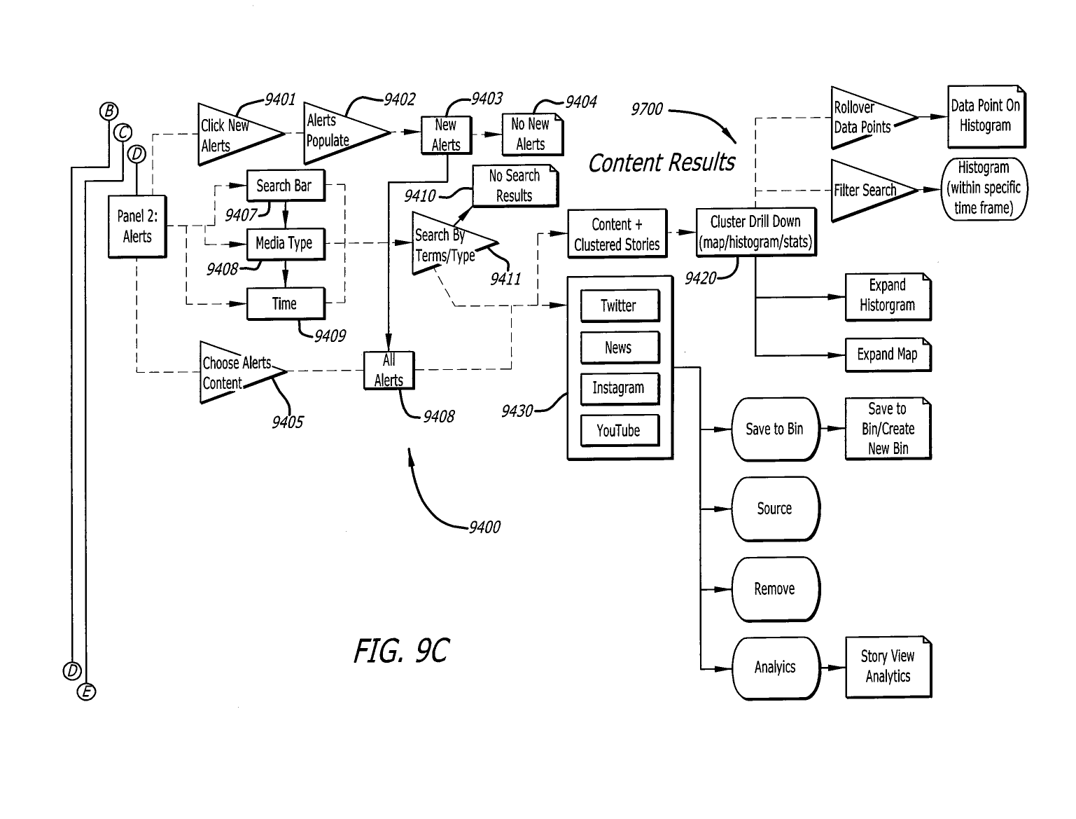

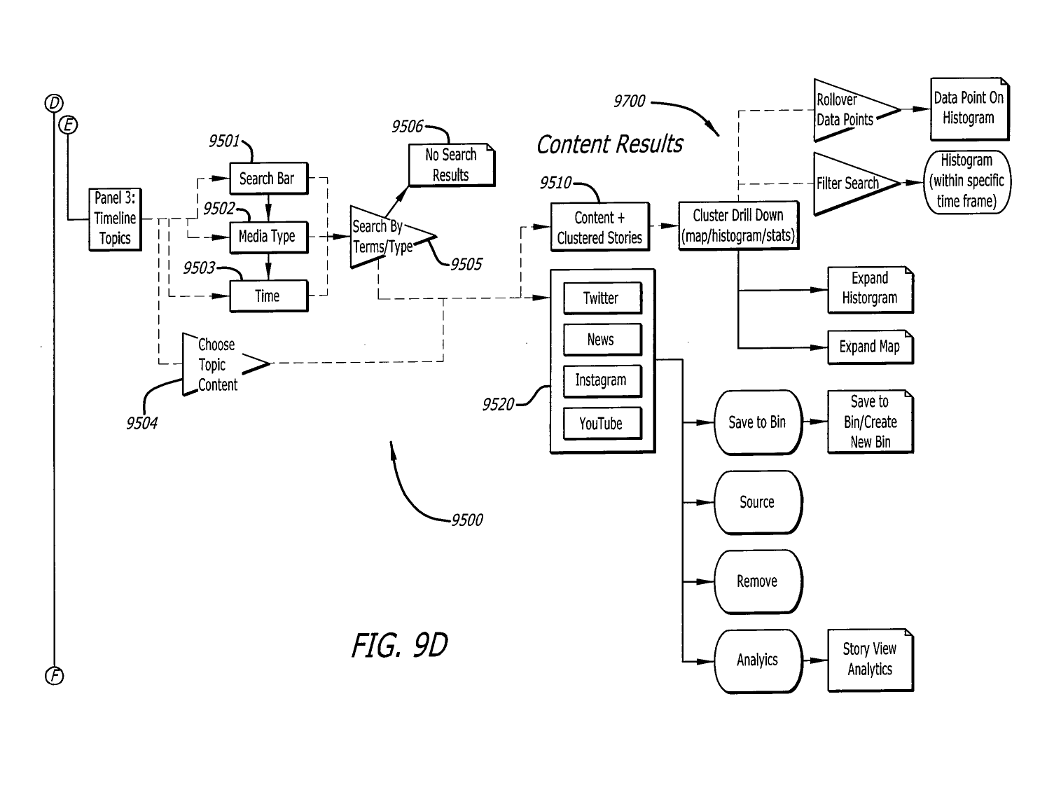

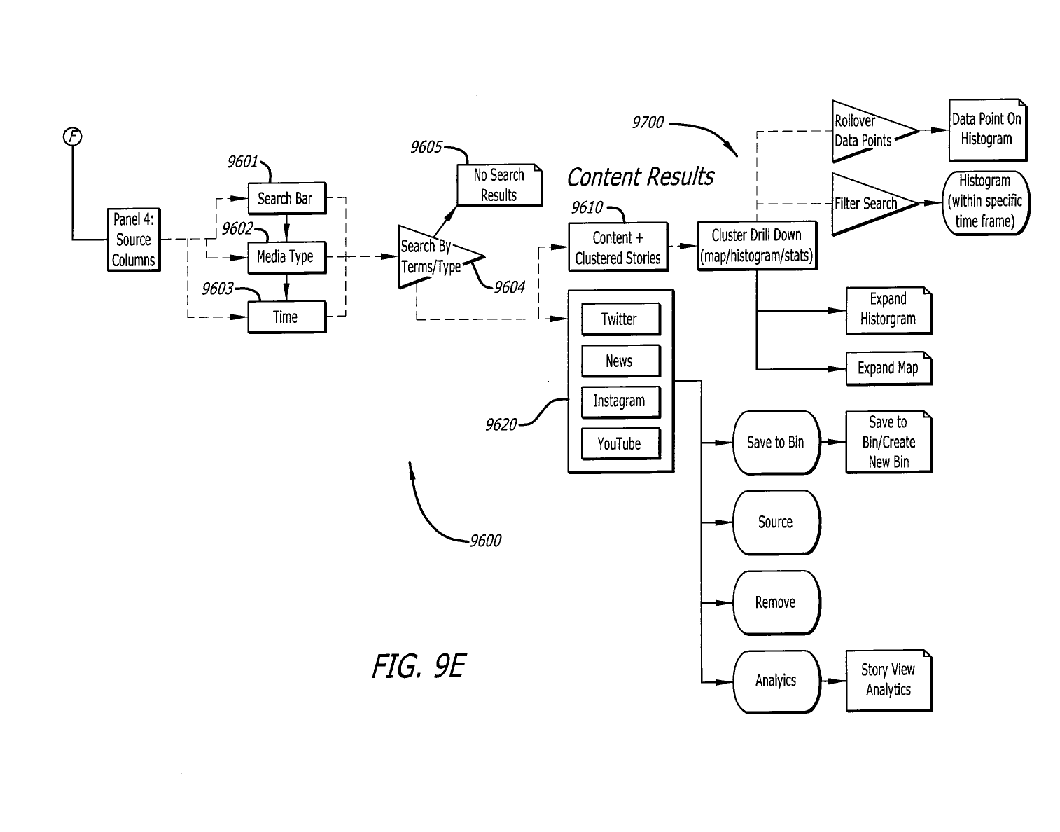

FIGS. 9A-9E illustrate an exemplary flow chart of one potential embodiment of a system for display and finding trending and breaking new content from social media websites.

System 900 may present a user with different options depending on whether this is the first time the user has logged in to system 900, box 9101 or any subsequent time 9104. If it is the first time, user may be presented with a welcome screen 9102. After logging in the user may be taken to the main “discover” application 9103/9105 used to discover news content.

Upon entering discover, the user may be presented with a navigation with a plurality of selectable options. One of those options may be to view the discover product 9201. In the navigation the user may be presented with a plurality of selectable options. Examples in including Top Trending Stories 9202, breaking news or “alerts” 9203, predefined news streams 9204, an ability to see additional content discovery options 9205, or the option to perform custom searches on social networks 9206. Selecting the predefined news streams 9204 may present the user with a list of topics to select from 9207. Selecting a social network to search at 9206 may present the user with a choice of which social network to search at 9209. Selecting any stream to view or search may add an additional column of trending or breaking news content to the UI at one of 9210, 9211, 9212, 9213 or 9214. Once a column has been opened, a user may be presented with several options including toggling between expanded or condensed views 9231, searching the column by keywords or filtering the content by type such as photo, video, articles, or social posts 9232, rearrange the columns through dragging and dropping 9233, or closing a column 9234.

At 9300 a user may be able to interact with the Trending Stories panel. Actions may including filtering the data through a search bar 9301, by media type 9302, or by time 9303. At 9304 these various filters are applied and either no data matches the results 9305 or those matching results are returned at 9306. If content is available, results may be selected at 9307. Results may be clustered at 9310. Results may be of various types including, but not limited to Twitter data 9321, news articles 9322, Instagram photos 9323 or YouTube videos 9324.

At 9400 a user may be able to interact with the breaking news or alerts column. In the alerts column, system may check for new alerts at 9401, populate the column with new alerts at 9402, and present to the user new alerts at 9403. It is also possible there are no new alerts 9404. Alerts may be filtered by text via a search bar at 9407, by media type at 9408, or by time 9409. Searches may return no results 9410. All alerts in the system may be available at 9406. Alert content may be clustered at 9420 and content that is in the alert state may be classified by various types at 9430 including but not limited to Twitter, Facebook, Photo, Instagram, YouTube, Vimeo, and the like.

A column populated by data from the news tracker system may be available at 9500. User may be able to filter the data by search terms via a search bar 9501, media type 9502 or time 9503. Searched content may then be made available at 9505. Filters may also return no matches 9506. Un-filtered content may be available at 9504. Content in news tracker columns may be clustered at 9510 and may also be available by source type 9520 including but not limited to Twitter, Facebook, Web Articles, Instagram, YouTube, Vimeo, and the like.

A column for custom searching a social media website may be made available at 9600. A user may be able to search by text through a search bar 9601, or search by media type 9602, or by time 9603. These search results are then returned at 9604. It may be possible that there will be no matching search results 9605. Results that are returned may be clustered at 9610 or may be labeled and handled differently depending on their content type at 9620, including but not limited to: Twitter, Facebook, Instagram, Web Articles, YouTube, Vimeo, and the like.

For any column in the UI described in 9300, 9400, 9500, or 9600 the user may make additional actions at 9700. Such actions may include drilling down into a cluster for additional detail 9701. Such a drill down may list all the items in the cluster. In another embodiment, such a drill down may include various analytics around the cluster such as a histogram or a map. A user may be able to expand the histogram 9706 or expand the map 9708 for more detail. A user may also be able to roll-over data points on the histogram 9702 to see more detail about the content at that particular time 9703. User may additionally be able to filter their search 9704 and return a histogram in an adjusted time region 9705.

In another embodiment, a user may take additional action for different pieces of content in the columns at 9700. Such actions may include saving the content to a bin or collection 9710 so that it may be easily accessed later. When saving content for later the user may add it to an existing storage bin or create a new one 9721. Content item may have the option to link out to the original source on the sources website 9711. Content item may have the option to remove it from the column 9712. Depending on the level of access of the user removal 9712 may just remove the content for the user, or for the entire account, or perform a system-wide removal. Content item may also have an analytics option 9713 which would open a new view 9722 that would show the user more details analytics around the content item. Such analytics might include a timeline of when it was shared, related content items, trending information on the item, and the like.

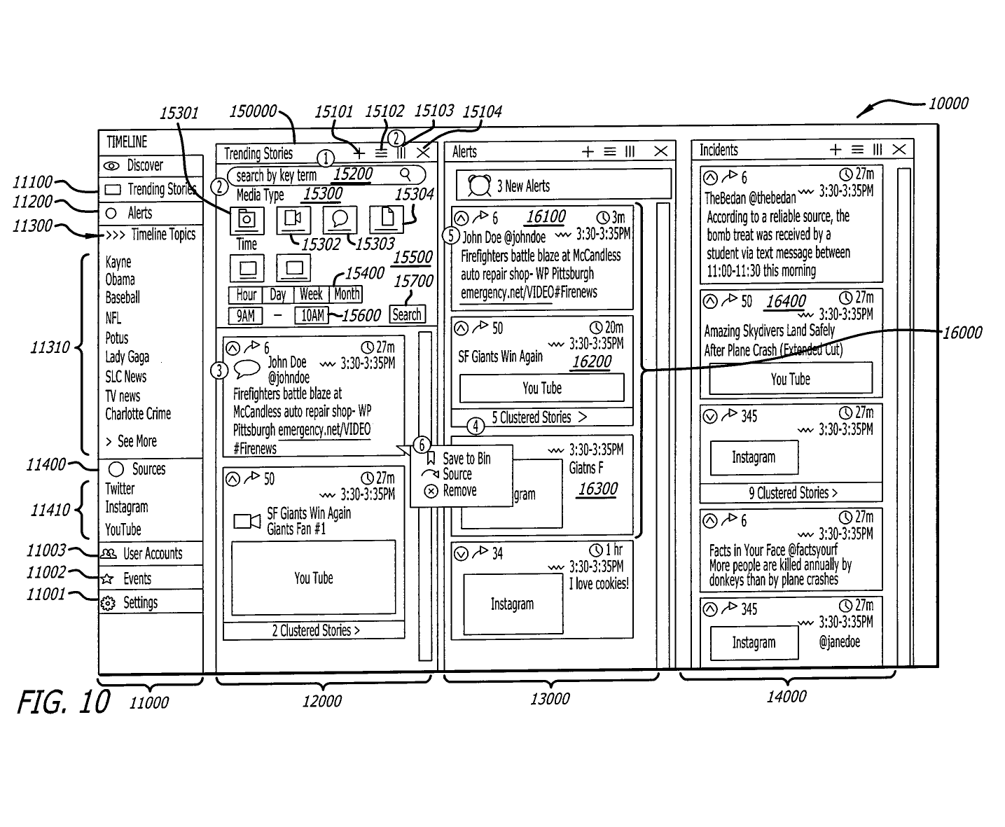

FIG. 10 illustrates an exemplary user interface for a trending and breaking news discovery system described in FIG. 9. System 10000 may have a navigation menu at 11000. Navigation menu may include a plurality of user selectable options which may include the ability to navigate to other parts of the system such as the CMS described in FIGS. 5 and 7 at 11002. User may be able to access their personal settings at 11003 and other system settings at 11001.

When in the News Discovery portion of the system of 10000 user may be able to select from a number of options including Trending Stories 11100 which may show what is trending across all topics and streams available to the user or they may browse the various news tracker streams available to them at 11300. The menu for the news tracker streams 11300 may also contain a sub-menu 11310 that allows the user to select from any of the topics available to them. User may browse breaking news stories in their streams at 11200. User may also have the option to search the social networks directly at 11400. The menu for search the social networks directly 11400 may also contain a submenu that allows the user to select different social networks that they wish to search at 11410 including but not limited to Twitter, Facebook, Instagram, and YouTube.

Selection any of the options Trending Stories 11100, Alerts 11200, any news tracker topic 11310, or social media source 11410 will open a new column in the UI at 12000, 13000, or 14000. Each column may have standard behaviors that are independent of the type of data displayed in that column 15000. These may include the ability to re-order the column via drag and drop controls 15101. There may also be a more detailed settings or options menu available via 15102. This may drop down an extended menu revealing more options. User may close out an entire column by clicking on 15104.

In the extended settings available at 15102 user may be able to search a column by keywords through a search box at 15200. User may also be able to filter the data displayed in the column by type at 15300. Clicking on 15301 might return only content items containing photos. 15302 might return only those items containing a video. 15303 may return just posts on social networks and clicking on 15304 may return only web articles that have been extracted from the social media messages. At 15400 user may be able to additionally filter the data by time. At 15401 user may be able to click and see a live view of the data that shows the most recent content coming in on the stream. At 15402 user may be able to see the content ordered by the ranking and scoring system of the news tracker system. At 15500 user may be able to sort the data by how many times it has been shared on the social network. They may additionally be able to see the share counts over different time intervals including by the last hour 15501, by the last 24 hours 15502, for the last week 15503, or the last month 15504. User may also be able to enter a custom time range over which they wish to see data at 15600. User may have the option to apply all their search conditions via a ‘search’ or similar button at 15700.

Actual content items in system 10000 may be displayed as “content cards” 16000. Each type of content may have a unique card such as a Twitter card 16100, an Instagram card 16300, a YouTube card 16400, and the like. A Twitter card might display the user's name 16101, their screen name 16102, the age of the content 16103, the number of shares 16104, whether the content is trending up or down 16105 and the text of the message 16106. A web link card such as a YouTube card may display the title of the video 16401, a video preview 16402, trending information 16403, share count 16404, and age 16405. An image type such as Instagram 16300 may show the image 16301, the username of the account that shared the image 16302, trending information 16303, the share count 16304, and the content age 16305. Additional types may display similar information but also additional fields that may be specific to that type of content.

Content items may also have an additional type called a “cluster” 16200. A cluster is a set of related content items as determined by the news tracker system through its clustering algorithm. A cluster 16200 may display the most important item in that cluster as determined by the ranking and scoring system of the news tracker system 16210 according to the formatting rules described above. A cluster may also display an indicator of how many clustered item there are 16220 and a user selectable button that would present an expanded view of the content in the cluster 16230.

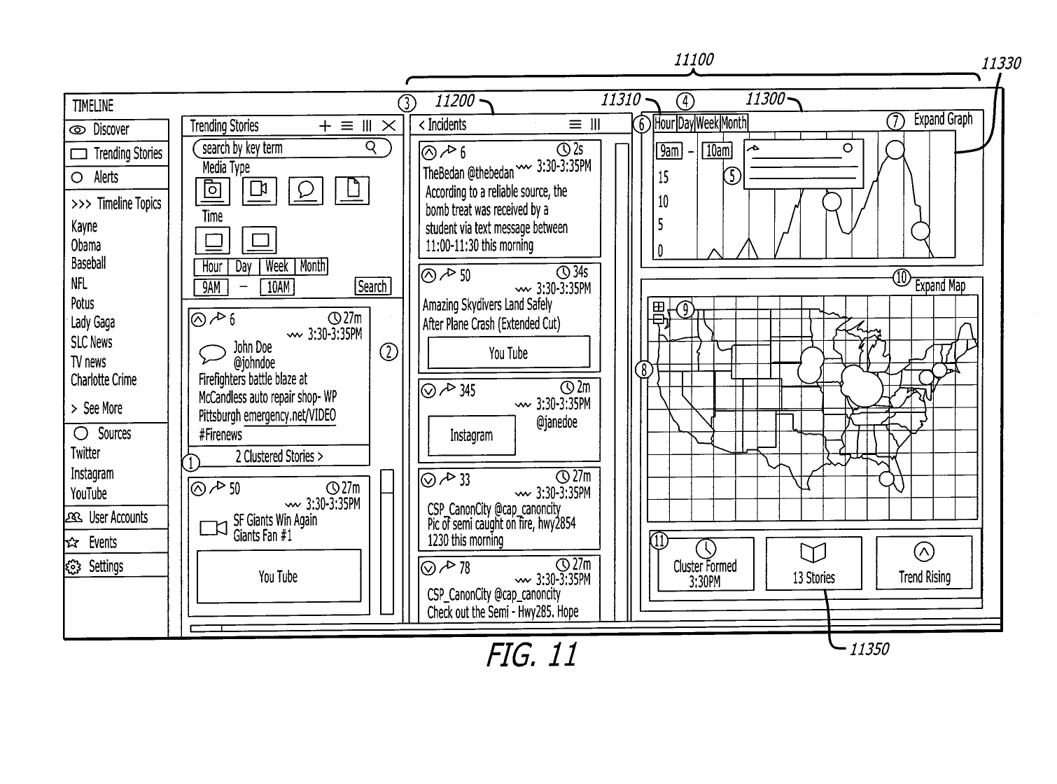

FIG. 11 illustrates an exemplary graphical user interface of an expanded view of a cluster of content from FIG. 10. GUI 110000 may open an additional panel 11100 with 2 additional columns. Column 11200 may show all the content items belonging to the cluster. Column 11300 may display additional analytics and metrics around the cluster itself. These may include, but are not limited to a timeline 11310, a map 11330, and analytics 11350.

Timeline 11310 may display the share count activity of the cluster over time. Timeline may include filters to adjust the time interval 11311. Time intervals may include for a single hour 11312, for a single day 11313, for a week 11314 or for a month 11315. There may also be a custom time selector available 11316. The timeline may also identify the time at which specific cluster items were first published on the time line through a dot or point or some other indicator 11317. a user may then be able to click or hover on that marker and get a shortened description of what that piece of content was 11318. There may be a button 11319 that allows the graph to be expanded to a larger format to present more information or make it easier to see the data that are being presented.

Map 11330 may display a heatmap of the world, a country, or a local map including roads and buildings that show where people have shared the content that is in the cluster. Map 11330 may include the ability to drag to change the location of the map 11331, the ability to zoom in and out 11332, and the ability to expand the map to a larger size to more easily see the displayed data 11333. Map may also support the ability to select regions where there have been posts and discover what content was most shared in that region 11335.

Analytics 11350 may also be provided on the cluster. These might include the time the cluster was formed 11351, how many items are in the cluster 11352, and the trending up or down of the cluster 11353. Additional information that might be displayed under analytics could include a graph of the cluster size over time, information on if and when the cluster was labeled as breaking news and trigger an alert in the news tracker system, and demographics breakdowns of the users sharing the content such as age, ethnicity, or gender.

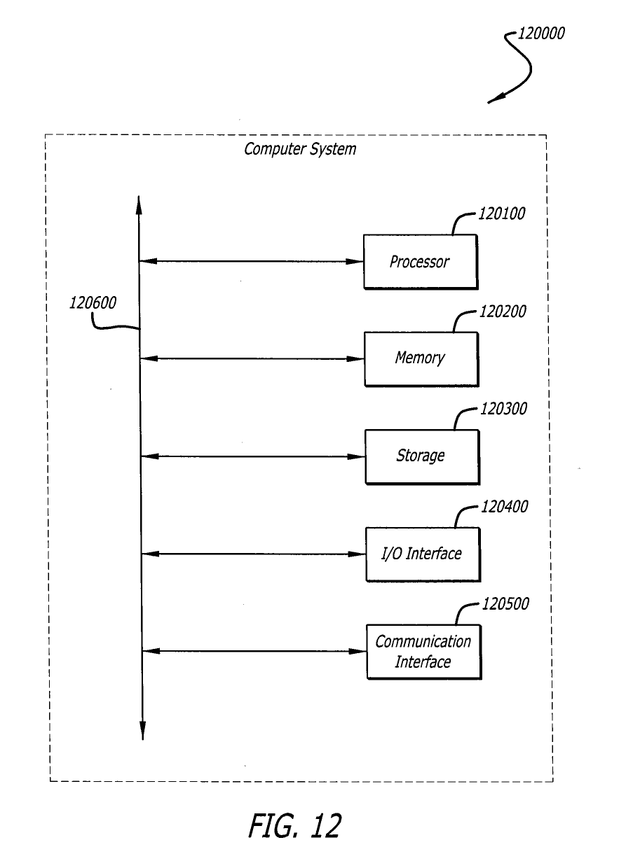

FIG. 12 illustrates an exemplary computer system 120000 which may be used with the various embodiments of the present invention. Computer system 120000 may take any suitable form, including but not limited to, an embedded computer system, a system-on-chip (SOC), a single-board computer system (SBC) (such as, for example, a computer-on-module (COM) or system-on-module (SOM)), a laptop or notebook computer system, a smart phone, a personal digital assistant (PDA), a server, a tablet computer system, a kiosk, a terminal, a mainframe, a mesh of computer systems, and the like. Computer system 120000 may be a combination of multiple forms. Computer system 120000 may include one or more computer systems 120000, be unitary or distributed, span multiple locations, span multiple systems, or reside in a cloud (which may include one or more cloud components in one or more networks).

In one embodiment, computer system 120000 may include one or more processors 120100, memory 120200, storage 120300, an input/output (I/O) interface 120400, a communication interface 120500, and a bus 120600. Although this disclosure describes and illustrates a particular computer system having a particular number of particular components in one particular arrangement, this disclosure contemplates other forms of computer systems having any suitable number of components in any suitable arrangement.

In one embodiment, processor 120100 includes hardware for executing instructions, such as those produced by software programs. Herein, reference to software may encompass one or more applications, byte code, one or more computer programs, one or more executables, one or more instructions, logic, machine code, one or more scripts, or source code, and vice versa, where appropriate. As an example and not by way of limitation, to execute instructions, processor 120100 may retrieve the instructions from an internal register, an internal cache, memory 120200 or storage 120300; decode and execute them; and then write one or more results to an internal register, an internal cache, memory 120200, or storage 120300. In one embodiment, processor 120100 may include one or more internal caches for data, instructions, or addresses. Memory 120300 may be random access memory (RAM), static RAM, dynamic RAM or any other suitable memory. Storage 120500 may be a hard drive, a floppy disk drive, flash memory, an optical disk, magnetic tape, or any other form of storage device that can store data (including instructions for execution by a processor).

In one embodiment, storage 120300 may be mass storage for data or instructions which may include, but is not limited to, a HDD, solid state drive, disk drive, flash memory, optical disc (such as a DVD, CD, Blueray, and the like), magneto optical disc, magnetic tape, or any other hardware device which stores may store computer readable media, data and/or combinations thereof. Storage 120300 may be internal or external to computer system 120000 and may be located remotely from computer system 120000, but in communication with computer system 120000, or accessible by computer system 120000.

In one embodiment, input/output (I/O) interface 120400, includes hardware, software, or both for providing one or more interfaces for communication between computer system 120000 and one or more I/O devices. Computer system 120000 may have one or more of these I/O devices, where appropriate. As an example but not by way of limitation, an I/O device may include one or more mouses, keyboards, keypads, cameras, microphones, monitors, displays, printers, scanners, speakers, cameras, touch screens, trackball, and the like.

In still another embodiment, a communication interface 120500 includes hardware, software, or both providing one or more interfaces for communication between one or more computer systems or one or more networks. Communication interface 120500 may include a network interface controller (NIC) or a network adapter for communicating with an Ethernet or other wired-based network or a wireless NIC or wireless adapter for communication with a wireless network, such as a WI-FI network. In one embodiment, bus 120600 includes hardware, software, or both coupling components of a computer system 120000 to each other.

While particular embodiments of the present invention have been described, it is understood that various different modifications within the scope and spirit of the invention are possible. The invention is limited only by the scope of the appended claims.

We claim:

1. A computer implemented method for identifying news items from a social media data stream, comprising:
receiving social media data signals transmitted from a social media server;
analyzing the received social media data signals to identify individual social media content items contained in the social media data signals;
categorizing the individual social media content items;
analyzing the categorized social media content items to determine a scoring value for each categorized social media content item; and
ranking the categorized news social media content based on the scoring value of each categorized social media content item.

2. The method of claim 1, wherein determining the scoring value for a categorized social media content item includes clustering similar categorized social media content items, and analyzing selected parameters associated with the cluster to determine the scoring value for the categorized social media content item.

3. The method of claim 1, wherein the analyzing the categorized social media content items to determine a scoring value of each categorized social media content item includes analyzing parameters selected from the group of parameters consisting of a number of times the categorized social media content item is shared, a value related to changes in the rate of shares of the social media content item over a selected time period, and a value related to a time that the social media content item was first received.

4. The method of claim 1, further comprising transmitting each individual social media content item through a natural language processor specifically programmed to determine a content value associated with the individual social media content item, and annotating each individual social media content item based on the content value.

5. The method of claim 1, wherein categorizing the social media content items includes categorizing the social media content items in accordance with a geolocation value related to the social media content item.

6. The method of claim 5, wherein the geolocation value is determined by identifying keywords or linguistic features associated with the social media content item.

7. The method of claim 6, wherein the keywords or linguistic features are related to a specific location.

8. The method of claim 7, wherein the specific location is selected from the group of locations consisting of towns, cities, regions and countries.

9. The method of claim 5, wherein the geolocation value is determined by predicting the geolocation of a user associated with the social media content item based on data related to the user.

10. The method of claim 9, wherein the data related to the user is determined by analyzing social connections associated with the user.

11. The method of claim 9, wherein the data related to the user is determined by analyzing posting data history data associated with the user.

12. The method of claim 2, further comprising transmitting a data item associated with the clustered social media content item the number of categorized social media content item in a cluster exceeds a predetermined threshold.

13. A system comprising:
one or more processors;
logic encoded in one or more non-transitory computer-readable media that, when executed by the one or more processors, is operable to:
receive signals associated with social media content data from a social media website,
transform the received signals associated with social media content data into social media content items,
categorize the social media content items into different news categories,
analyze the categorized social media content items to determine a scoring value for each categorized social media content item, and
rank each of the categorized social media content items based on the scoring value of the categorized social media content item.

14. The system of claim 13, wherein the scoring value is determined from data in the group of data consisting of a number of times the social media content item is shared, a value related to changes in the rate of shares of the social media data item over a selected time period, and a value related to a time that the social media content item was received.

15. The system of claim 13, wherein the logic encoded in one or more non-transitory computer-readable media that, when executed by the one or more processors, is further operable to cluster similar categorized social media content items, and to determine a scoring value for the clustered social media content items.

16. The system of claim 15, wherein the logic encoded in one or more non-transitory computer-readable media that, when executed by the one or more processors, is further operable to transmit a data item associated with the clustered social media data items to a user when the scoring value exceeds a predetermined threshold.

17. The system of claim 16, wherein the data item is transmitted to a user in a form selected from the group consisting of an email, a text message, a push notification and a visual display.

18. A system for identifying news from social media comprising:
one or more processors configured to:
receive signals associated with social media data from a social media website,
transform the signals associated with social media data into social media content items,
categorize the received social media content items in accordance with a set or preselected parameters, one of which may be a locality associated with the social media content item,
score the social media content item to determine a scoring value associated with the social media content item,
create clusters of the scored social media content items in accordance with cluster values determined from the scored social media content items,
determine a meta score for each cluster, and
rank the clusters of social media content items in accordance with the meta score of each cluster.

19. The system of claim 18, wherein the one or more processors are further configured to determine a frequency value related to a number of times a social media content item has been shared, an acceleration value related to a change in the rate of shares of the social media content item over a selected time period, and an origination time value related to a time that the signal associated with a social media content item was first received from the social media website.

20. The system of claim 19 wherein the one or more processors are further configured to display the frequency value, the acceleration value and the origination time value associated with a social media content item in a graphical user interface.

21. A computer implemented method for identifying and obtaining rights clearance for social medial content items to be displayed to a user, comprising:
receiving social media data signals transmitted from a social media server;
transforming the social media data signals into individual social media content items;
analyzing the individual social media content items to identify whether clearance from an originator of the social media content item is required before the social media content item can be displayed to a user;
searching a database containing clearance information associated with social media content originators and determining if the originator of the social media content item has granted clearance to display the social media content item and acquiring clearance from the originator if clearance is needed; and
displaying the social media content item to the user.

22. The method of claim 21, wherein acquiring clearance from the originator includes automatically contacting the originator and requesting clearance for the social media content item and processing the originator's reply before the social media content item is displayed to the user.

23. The method of claim 22, wherein the database containing clearance information associated with social media content originators is updated automatically as new social media content signals are received and transformed into social media content items.
